(19) United States
(12) Patent Application Publication
(10) Pub. No.: US 2006/0131868 A1
(43) Pub. Date: Jun. 22, 2006

(54) Method for making calendar

(76) Inventor: Kazuhiro Matsuda, Kouto-ku (JP)

Correspondence Address: RABIN & Berdo, PC, 1101 14TH STREET, NW, SUITE 500, WASHINGTON, DC, 20005, US

(21) Appl. No.: 10/533,287

(22) PCT Filed: Oct. 30, 2002
(86) PCT No.: PCT/JP02/11261

§ 371 Date: Nov. 16, 2005

(51) Int. Cl. B42D 15/00

(52) U.S. Cl. 283/67

(57) ABSTRACT

A method for making a calendar characterized in that one month is fixed with 31 days and standardized, the days are arranged laterally or longitudinally in units of 7 days, space parts indicative of the month and 7 days of a week are provided contiguously to the first week on a table divided into 5 weeks, 1-7 days are written in the first week, 8-14 days are written in the second week, 15-21 days are written in the third week, 22-28 days are written in the fourth week, and 29-31 days are written in the fifth week, month and 7 days of a week are indicated in specified space parts by a user using an auxiliary indicator, e.g. a seal, attached to the product, and the year and month of using the calendar can be determined freely with reference to the part of days.

### THE FIELD OF THE INVENTION

This invention relates to a manufacturing method for calendars such as dairies, pocketbooks, reporting books, and housekeeping books, which are settled and normalized on a basis of one month as 31 days and in which days are divided vertically into seven day blocks or horizontally five week blocks to allow the users to indicate the month and days of the week at a prescribed blank in using attached supplemental indication tools to render this indication correspond to table of day number, thereby allowing the users to decide date to be used freely.

### TECHNOLOGY BACKGROUND

In conventional products, for instance, business diaries, daily information filling columns are entirely used only for the specified day, and had an expiration period for use. Each page information of such a product may be looked as the same, but there were slight differences because dates of year, months, and days of week are set unchangeably. Each page of products, except simple diaries, is printed individually and cannot be standardized, resulting increases of manufacturing costs and resources, and making worse the production yield.

Products of this kind are largely sold at bookstores or office product shops each year during periods from autumn to the beginning of year, at a time when consumers buy to replace it with a new one. It is settled in the market that if the time comes close to the expiration date of the products, the products are subject to discount sales or returned to the makers or the like. Loose leaf products have been known to the public, but such a product also have an expiration date for use. Moreover, we have found that in many situations this season is the only chance for selling calendars as products.

Therefore, as technology of diary products as well as board products having functions of calendar characterized in that the users can freely decide the date to use, it is an object of the invention to provide a calendar manufacturing method to solve various problems unsolved with conventional products, such as, e.g., excessive amounts of resources in information printing or processing specific dates, severe burden on sales and distribution management on discounted sales or returned goods due to the expiration, unsolved problems on costs reflected on the price, resources, and surroundings, consumers' inability to solve problems on burden on unnecessary costs of sold products or environmental matters, and difficulties on free replacement to be done by users regardless the season or on efficient supplies of the products.

### SUMMARY OF THE INVENTION

According to the invention, a method for manufacturing a calendar includes the steps of: forming five sheets divided weekly by placing day numbers vertically or horizontally on a basis of seven days where a month is standardized as having thirty one days; forming a blank section for indicating month and days of the week at a left end or upper end of the sheet of the first week; and placing the day numbers of first to seventh on the sheet of the first week, day numbers of eighth to fourteenth on the sheet of the second week, day numbers of fifteenth to twenty first on the sheet of the third week, day numbers of twenty second to twenty eighth on the sheet of the fourth week, and day numbers of twenty ninth to thirty first on the sheet of the fifth week, whereby a user is freely able to decide when the sheets are used, upon placing, on the blank section arranged at the sheet of the first week, an indication supplemental tool such as an attached seal corresponding to the month and seven days of the week, thereby allowing to provide various products solving above problems on costs, environments, distributions regarding conventional products.

Information on holidays and others provided to conventional products may be supplied with appendixes of the products, or each user may retrieve such information through the Internet or book information. By using the same principle, users can make their calendar or board with a perpetual calendar function.

### BRIEF DESCRIPTION OF THE DRAWINGS

FIG. 1 is an embodiment of a product to which the invented method applies;

FIG. 2 is a diagram showing the principle of this invention independent from the nature of products; and

FIG. 3 is applied methods for calendars, display boards, etc.

### THE BEST MODE FOR EMBODYING THE INVENTION

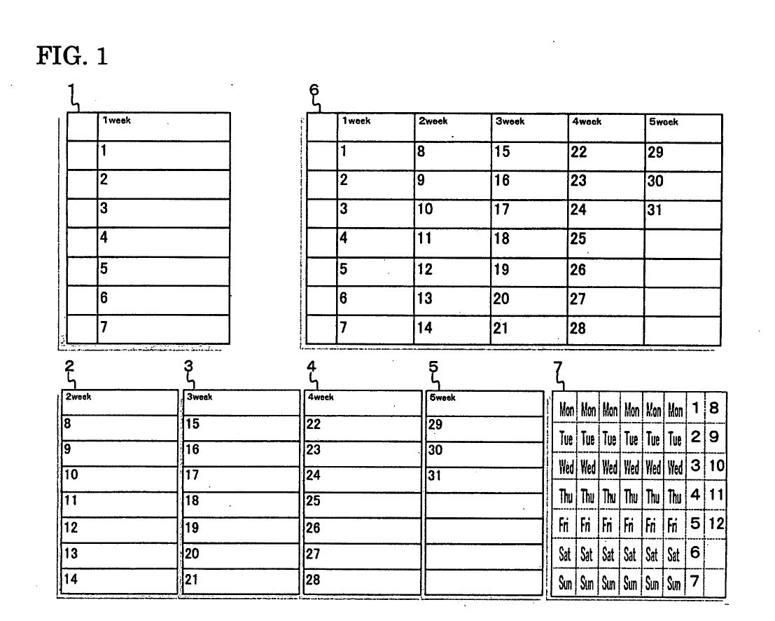

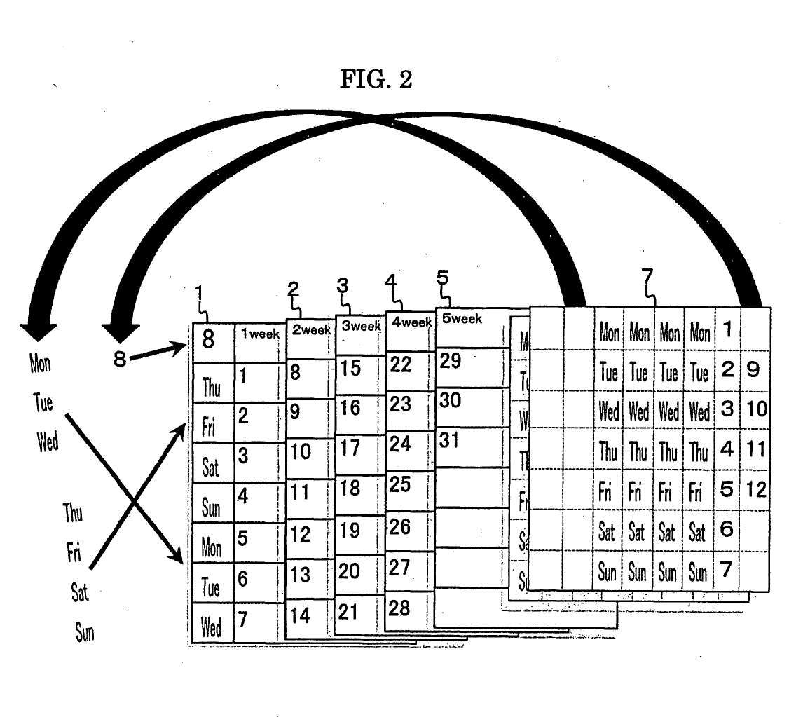

Referring to Figures, this invention is further described in detail. FIG. 1 shows a structural embodiment of a product to which this invention applies. The product using the manufacturing method for calendar of the invention is used for, e.g., bible-type paper pocketbook, A4-sized table diary, and household accounting book. FIG. 2 is a diagram showing the principle of this invention independent from the nature of products. A detailed product is shown in FIG. 2. One month is settled and standardized in 31 days, and the day numbers arranged horizontally or vertically are basically divided into five sheets corresponding five weeks.

A blank section wider than that of sheets 2 to 5, on which the month and days of the week are indicated, is formed at the left or top end of sheet 1, and the day numbers of first and seventh are placed on the sheet 1. The day numbers of eighth to fourteenth are placed on the sheet of the second week; the day numbers of fifteenth to twenty first are placed on the sheet of the third week; the day numbers of twenty second to twenty eighth are placed on the sheet of the fourth week, and the day numbers of twenty ninth to thirty first are placed on the sheet of the fifth week; and each information recording section is also provided respectively.

With this manufacturing method for calendar, which applies to a product having a feature that the user can freely decide the date to be used, the month and days of the week indicated by indication supplemental tool 7 made of, e.g., paper seals attached to this product are made corresponding to the actual date.

The tool 7 as an appendix to this product provides information of specific days and information of national holidays, memorial days, full and new moon days, and others to the product, thereby rendering easy information researching and filling of the blanks, and thereby rendering the usage of the product easy. To avoid this invention having no expiration date from becoming less useful, the tool 7 is made mainly for information not depending the date, and where the tool 7 is made of paper seals, the seals are provided with a material or materials durable for a prescribed period against tough use environment such as higher temperature and higher humidity, and information is made readily separated individually to be easily pasted on the sheet 1 upon providing with perforations. The paste to be used does not fall off and is preferably made of a suitable, readily handled material. The material should be chosen in consideration of environmental problems.

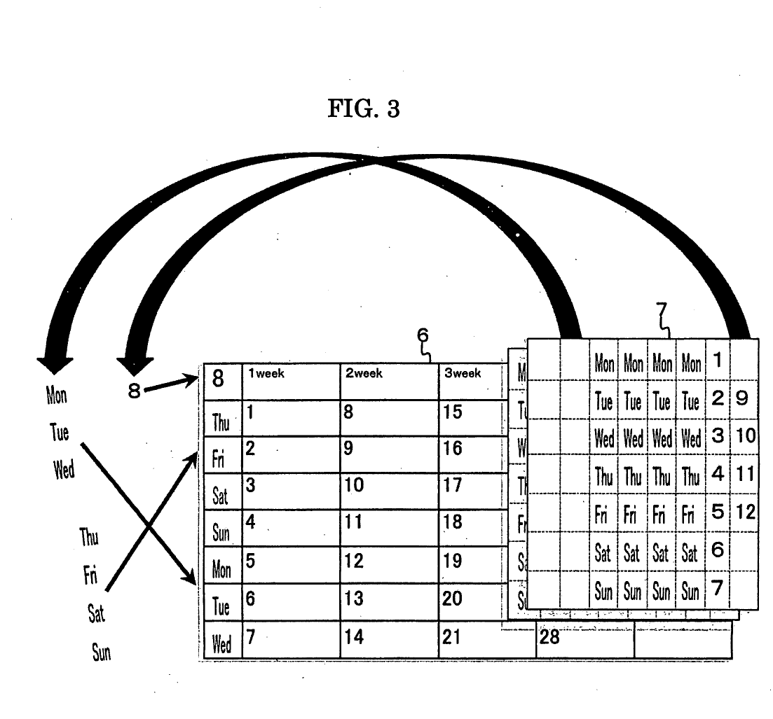

FIG. 3 is a conceptual-diagram of the principle of this invention, whose product is to be used as a calendar or board. Months may be printed in advance except for a product used as a perpetual calendar, because the product may be used all year round.

This invention is also applicable to perpetual calendar indication methods on white boards and schedule boards. With a board having a function of a table 6 shown in FIG. 1, at that time, the tool 7 can be an appendix having the same functions as described above and being made of, such as, e.g., magnet, seal, electrostatic as detachably attached.

Further, the invention is operable as “a bridge” between current calendars and the world calendars, which was proposed at the United Nations as a strong candidate for new calendar with 28 days per month and 13 months per year.

### INDUSTRIAL APPLICABILITY

As described above, the calendar manufacturing method according to this invention can reduce various costs through normalized specifications and removal of the time limitations, thereby rendering mass production and distribution management of the products easier, and rendering profits increase, as well as contributing the environmental problems. Consumers can subjectively overcome some difficulties raised in conventional business diaries, dairies, pocketbooks, reports, household accounting books, and calendar sheets, which have conventional calendar functions, and can be used usefully in comparison with conventional products and make contribution to the environment.

In addition, use of the method for manufacturing calendar according to this invention provides the products having features that the calendar always starts with first day orderly upon unifying the monthly style, that information associating with year, month, and day can be easily stored, sorted, searched, and utilized as data in a way simpler than the conventional products, and that users can decide freely the date to be used by indicating the month and days of the week regardless the beginning day for use.

What is claimed is:

1. A method for manufacturing a calendar comprising the steps of:
forming five sheets divided weekly by placing day numbers vertically or horizontally on a basis of seven days where a month is standardized as having thirty one days;
forming a blank section for indicating month and days of the week at a left end or upper end of the sheet of the first week; and
placing the day numbers of first to seventh on the sheet of the first week, day numbers of eighth to fourteenth on the sheet of the second week, day numbers of fifteenth to twenty first on the sheet of the third week, day numbers of twenty second to twenty eighth on the sheet of the fourth week, and day numbers of twenty ninth to thirty first on the sheet of the fifth week,
whereby a user is freely able to decide when the sheets are used, upon placing, on the blank section arranged at the sheet of the first week, an indication supplemental tool such as an attached seal corresponding to the month and seven days of the week.

2. A method for manufacturing a calendar comprising the steps of:
forming a table on one sheet in which day numbers are placed vertically or horizontally on a basis of seven days where a month is standardized as having thirty one days;
forming a blank section for indicating month and days of the week at a left end or upper end of the table; and
placing the day numbers of first to seventh on the table of the first week, day numbers of eighth to fourteenth on the table of the second week, day numbers of fifteenth to twenty first on the table of the third week, day numbers of twenty second to twenty eighth on the table of the fourth week, and day numbers of twenty ninth to thirty first on the table of the fifth week, where the first to fifth weeks are arranged from the left or from the top,
whereby a user is freely able to decide when the sheet is used, upon placing, on the prescribed blank section, an indication supplemental tool such as an attached seal corresponding to the month and seven days of the week.

3. A method for manufacturing a calendar comprising the steps of:
preparing a table on a white board made of a magnetic material on which any information can be written and erased with a specific pen and an eraser;
forming the table in which day numbers are placed vertically or horizontally on a basis of seven days where a month is standardized as having thirty one days;
forming a blank section for indicating month and days of the week at a left end or upper end of the table; and
placing the day numbers of first to seventh on the table of the first week, day numbers of eighth to fourteenth on the table of the second week, day numbers of fifteenth to twenty first on the table of the third week, day numbers of twenty second to twenty eighth on the table of the fourth week, and day numbers of twenty ninth to thirty first on the table of the fifth week, where the first to fifth weeks are arranged from the left or from the top,
whereby a user is freely able to decide when the board is used, upon placing a supplemental tool utilizing such as magnet, seal, electrostatic for indication of the month and seven days of the week as detachably attached on the prescribed blank section to correspond to the portion of the day numbers.
